(19) United States
(12) Patent Application Publication
(10) Pub. No.: US 2023/0361266 A1
(43) Pub. Date: Nov. 9, 2023

(54) METHOD OF IMPROVING ELECTRODE-TO-SOLID-ELECTROLYTE INTERFACE CONTACT IN SOLID-STATE BATTERIES

(71) Applicant: UT-Battelle, LLC, Oak Ridge, TN (US)

(72) Inventors: Anand Vasudevbhai Parejiya, Oak Ridge, TN (US); Ruhul Amin, Oak Ridge, TN (US); Marm Dixit, Oak Ridge, TN (US); Rachid Essehli, Oak Ridge, TN (US); Ilias Belharouak, Oak Ridge, TN (US)

(21) Appl. No.: 18/142,086

(22) Filed: May 2, 2023

Related U.S. Application Data
(60) Provisional application No. 63/337,697, filed on May 3, 2022.

(51) Int. Cl. H01M 4/04

(52) U.S. Cl. CPC H01M 4/045; H01M 4/0407

(57) ABSTRACT

A method of improving interfacial contact at an electrode-to-solid-electrolyte interface in a solid-state battery cell is provided. The method includes providing a solid-state battery cell including a solid-state electrolyte and electrodes defining an anode and a cathode. Each of the anode and cathode are adjacent to the solid-state electrolyte at an interface. The method further includes electrochemically increasing interfacial contact between at least one of the electrodes and the solid-state electrolyte by applying a voltage pulse to the cell at a high current density for a short duration, wherein electrode material diffuses into pores formed in the solid electrolyte interface, thereby healing the pores and eliminating an interfacial space charge effect.

### CROSS REFERENCE TO RELATED APPLICATIONS

This application claims the benefit of U.S. Provisional Application No. 63/337,697, filed May 3, 2022, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to solid-state batteries, and more particularly to the anode to solid-state electrolyte interface in solid-state batteries.

### BACKGROUND OF THE INVENTION

Solid-state batteries (all-solid-state batteries (ASSBs) or simply SSBs, i.e. solid-state batteries) are batteries that use solid material(s) instead of a liquid electrolyte to carry metal ions between the electrodes of the battery. SSBs have lower flammability, higher electrochemical stability, and higher energy density in comparison to liquid electrolyte batteries. For example, the energy density and safety advantages of SSBs are enabled by the use of a Li-metal anode and the elimination of flammable solvents that are used in conventional lithium-ion batteries. SSBs are also lighter and faster to charge than liquid electrolyte batteries.

However, heterogeneous contact at the anode/solid electrolyte interface is a limiting parameter for the safe and high performance of SSBs. The heterogeneity of the contact refers to the differences in material composition of the anode in comparison to the material composition of the solid electrolyte, rather than in a difference in chemical state (e.g., solid, liquid). Heterogeneous contact can lead to pore formation and propagation at the anode/solid electrolyte interface during charge-discharge cycles. The resulting pores promote inhomogeneous current density at the interface and increased interfacial resistance, which leads to local mechanical stresses. Pore formation, inhomogeneous current distribution, and local stresses ultimately may lead to battery failure due to contact loss and chemo-mechanical degradations. Despite the abundance of explanations for the physical contact loss supported by experiments and theory, the solution strategies reported in literature are scarce and all of them add either system complexity or fabrication cost of SSBs. Forming and maintaining an intimate contact at the electrode/electrolyte interface is a key requirement for high-rate-performance SSBs. Thus, a need exists to explore material-agnostic strategies to prevent physical interfacial contact loss of anode to solid electrolyte in order to increase cycle life and obtain high performance SSBs.

### SUMMARY OF THE INVENTION

A method of electrochemically improving interfacial contact at an electrode-to-solid-electrolyte interface in a solid-state battery cell is provided. The method includes providing a solid-state battery cell including a solid-state electrolyte and electrodes defining an anode and a cathode. Each of the anode and cathode are adjacent to the solid-state electrolyte at an interface. The method further includes electrochemically increasing interfacial contact between at least one of the electrodes and the solid-state electrolyte by applying a voltage pulse to the cell at a high current density for a short duration, wherein electrode material diffuses into pores formed in the solid electrolyte interface, thereby healing the pores and eliminating an interfacial space charge effect.

In specific embodiments, the voltage pulse has a cut-off voltage having an absolute value greater than or equal to 20 V at the cell level. The cut-off voltage may be higher or lower depending on configurations of battery modules and packs.

In particular embodiments, the cut-off voltage of the voltage pulse has an absolute value greater than or equal to 10 V at the cell level.

In specific embodiments, the high current density applied to the cell is at least five times greater than the critical current density at the cell level. The current density may be higher or lower depending on configurations of battery modules and packs.

In specific embodiments, the high current density applied to the cell is greater than or equal to 10 mA cm⁻² at a cell level. Again, the current density may be higher or lower depending on configurations of battery modules and packs.

In specific embodiments, the short duration is greater than or equal to 0.1 ms.

In particular embodiments, the short duration is in a range of 0.1 to 0.5 ms.

In other embodiments, the short duration is less than 1 ms.

In specific embodiments, the voltage pulse includes more than one pulse cycle.

In specific embodiments, the solid-state electrolyte is one of an inorganic solid electrolyte, a solid polymer electrolyte, and a composite polymer electrolyte.

In particular embodiments, the solid-state electrolyte is one of a garnet, a NASICON, a LISICON, an argyrodite-like, a lithium nitride, a lithium hydride, a lithium halide, a lithium phosphorous oxynitride, a lithium thiophosphate, a perovskite, a polyether-based electrolyte, a polycarbonate-based electrolyte, a polyester-based electrolyte, a polynitrile-based electrolyte, a polyalcohol-based electrolyte, a polyamine-based electrolyte, a polysiloxane-based electrolyte, a fluoropolymer-based electrolyte, a gel polymer electrolyte, an ionogel electrolyte, and a gel electrolyte.

In specific embodiments, the anode comprises a Li-based active material, a Na-based active material, a K-based active material, a Mg-based active material, or a Zn-based active material.

In specific embodiments, the pores in the solid-state electrolyte are reduced or completely filled up due to local heating of the anode material at the interface in the vicinity of the pores.

In specific embodiments, the method is performed in-operando.

A solid-state battery cell having an electrochemical performance improved by the method is also provided.

These and other features of the invention will be more fully understood and appreciated by reference to the description of the embodiments and the drawings.

### BRIEF DESCRIPTION OF THE DRAWING

FIG. 1 is a schematic view of a method of improving interfacial contact at an electrode-to-solid-electrolyte interface in accordance with embodiments of the disclosure;

FIG. 2 is another schematic view of the method of improving interfacial contact;

FIG. 3 is a schematic view of current flow in the vicinity of a pore at a lithium metal to LALZO electrolyte interface;

FIG. 4 is a diagram of a COMSOL simulation showing current density increase at the vicinity of a pore region;

FIG. 5 is a graph of temperature change in lithium due to Joule heating in the vicinity of a pore as a function of pore size and shell size;

FIG. 6 is a graph of polarization curves for a symmetric Li/LALZO/Li cell (initially having poor interfacial contact due to the presence of pores) at an initial cycle, at a voltage pulse, and at a single cycle after voltage pulse run at room temperature;

FIG. 7 is a graph of EIS spectra for the symmetric Li/LALZO/Li cell before and after application of the voltage pulse in FIG. 6;

FIG. 8 is a graph of EIS spectra for a symmetric Li/LALZO/Li cell (initially having poor interfacial contact due to the presence of pores) before and after application of multiple voltage pulses;

FIG. 9 is a graph of polarization curves for the symmetric Li/LALZO/Li cell of FIG. 8 at an initial cycle and at cycles after each of multiple voltage pulses run at room temperature;

FIG. 10 is a graph of EIS spectra for a symmetric Li/LALZO/Li cell (having intimate interfacial contact, as assembled) before and after application of a voltage pulse;

FIG. 11 is a graph of polarization curves for the symmetric Li/LALZO/Li cell of FIG. 10 at an initial cycle, at a voltage pulse, and at a single cycle after voltage pulse run at 60° C.;

FIG. 12 is a graph of EIS spectra for a symmetric Li/LALZO/Li cell (having intimate interfacial contact, as assembled) before and after application of multiple voltage pulses; and

FIG. 13 is a graph of polarization curves for the symmetric Li/LALZO/Li cell of FIG. 12 at an initial cycle and at cycles after each of multiple voltage pulses run at 60° C.

### DETAILED DESCRIPTION OF THE CURRENT EMBODIMENTS

As discussed herein, the current embodiments relate to a method of electrochemically improving interfacial contact at an electrode-to-solid-electrolyte interface in a solid-state battery cell. Since the contact improvement is carried out electrochemically, the method is material-agnostic, i.e. without regard to the chemical composition of the electrode (anode or cathode) and solid electrolyte. The method is also non-destructive as it relates to the battery cell and is performed in-operando, thus being capable of implementation at the initial battery formation stage and/or during operation (charge/discharge) of the battery. Additionally, application of the method to symmetric cells does not show formation of dendrites. The method is therefore ideally integrated into battery management systems for all types of solid-state batteries regardless of chemical composition. The method can increase the lifetime and functionalities of solid-state batteries by repairing and/or preventing contact loss at the electrode/solid electrolyte interface which is crucial for stable battery operation, and also increasing the rate capability of solid-state batteries.

The method first includes providing a solid-state battery cell including a solid-state electrolyte (SSE or simply SE, i.e. solid electrolyte), an anodic electrode (anode), and a cathodic electrode (cathode), in which each of the anode and the cathode are adjacent the solid-state electrolyte and hence physically in contact with each other at an interface. In other words, the solid-state electrolyte is sandwiched between the anode and cathode. The composition of the electrodes is not particularly limited and may be any type/material suitable for the electrodes of a solid-state battery cell, such as an elemental metal, a metal alloy, a metal oxide, a metal sulfide, a metal phosphide, a metal nitride, a metal fluoride, a metal oxalate, a metal carbide, or a metal hydroxide. For example, the electrode may be a metal or a metal-containing compound, such as a Li-metal electrode including a Li-based active material, a Na-metal electrode including a Na-based active material, a K-metal electrode including a K-based active material, a Mg-metal electrode including a Mg-based active material, or a Zn-metal electrode including a Zn-based active material. In some embodiments of the method, the anode is Li metal or a Li-metal-containing compound. In a symmetrical cell, the anode has the same composition as the cathode. The solid-state electrolyte may be any one of an inorganic solid electrolyte, a solid polymer electrolyte, and a composite polymer electrolyte. In specific embodiments, the solid-state electrolyte is a garnet-type solid electrolyte such as an Al-doped LLZO garnet solid electrolyte. However, the solid-state electrolyte alternatively may be any composite, polymer, or other solid-state materials including oxides, sulfides, halides, phosphates, and/or polymers, such as but not limited to LISICON (e.g. LGPS, LiSiPS, LiPS), argyrodite-like (e.g., Li₆PS₅X, X=Cl, Br, I), garnets (e.g., LLZO, LALZO), NASICON (e.g., lithium-based NASICONs such as LTP, LATP, LAGP), lithium nitrides (e.g., Li₃N), lithium hydrides (LiBH₄), perovskites (e.g., LLTO), lithium halides (e.g., LYC, LYB), lithium phosphorous oxynitride (LIPON), lithium thiophosphates (Li₂S-P₂S₅), polyether (PEO)-based electrolytes, polycarbonate-based electrolytes, polyester-based electrolytes, polynitrile-based electrolytes (e.g., PAN), polyalcohol-based electrolytes (e.g., PVA), polyamine-based electrolytes (e.g., PEI), polysiloxane-based electrolytes (e.g., PDMS), fluoropolymer-based electrolytes (e.g., PVDF, PVDF-HFP), gel polymer electrolytes, Ionogel electrolytes, and gel electrolytes.

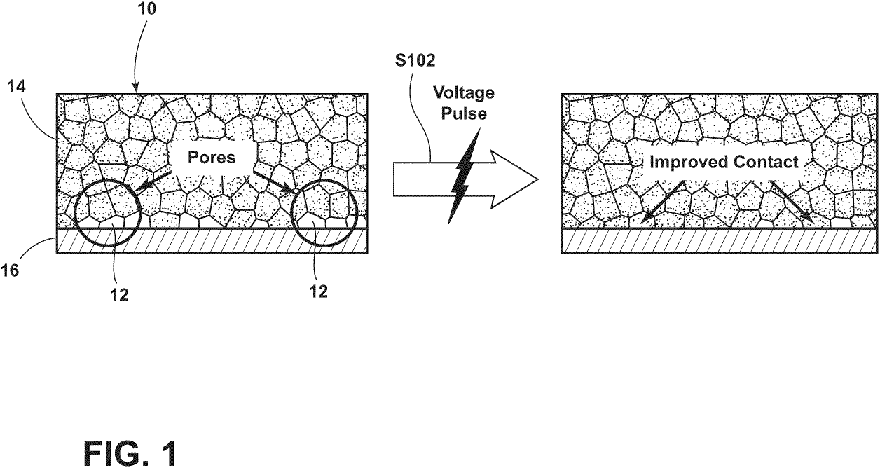

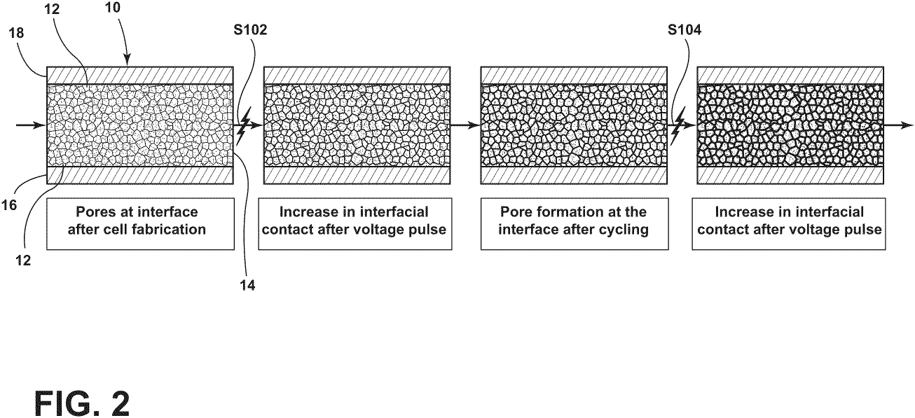

As shown in FIGS. 1 and 2, the battery cell 10 may have pores 12 formed in the solid-state electrolyte 14 at the interface between the solid-state electrolyte 14 and the anode 16 and/or at the interface between the solid-state electrolyte 14 and the cathode 18. To heal (reduce or eliminate) the pores that cause poor interfacial contact and to thereby eliminate an interfacial space charge effect in the battery cell, at step S102 the method further includes electrochemically increasing interfacial contact between at least one of the electrodes and the solid-state electrolyte by applying a voltage pulse to the cell at a high current density for a short duration. Application of the voltage pulse causes electrode material to diffuse into the pores formed in the solid-state electrolyte. As described in more detail below, the effectiveness of the method is based on Joule heating induced via the voltage pulse application for a short period of time which leads to local heating of electrode (e.g., anode) material at the interface near the pores. The resulting local heat leads to better diffusion of anode material into the pores and enhances anode creep which leads to reduction and elimination of pores and increases contact of anode material with the solid-state electrolyte.

The voltage pulse may have a cut-off voltage that is set to an absolute value greater than or equal to 5 V (i.e., the cut-off voltage is ±5 V), alternatively greater than or equal to 10 V (i.e., the cut-off voltage is ±10 V), alternatively greater than or equal to 15 V (i.e., the cut-off voltage is ±15 V), alternatively greater than or equal to 20 V (i.e., the cut-off voltage is ±20 V). The cut-off voltage is given at the cell level, i.e. it is a value that is present/measured/applied at the level of an individual battery cell and not at a bulk level, i.e. not an average across a plurality of cells. The cut-off voltage may be higher or lower than a range of ±5 V to ±20 V, and is dependent upon such factors as the battery cell composition and the configuration of battery modules and packs.

The high current density applied to the cell is preferably about five times greater than the critical current density (CCD) of the cell, optionally at least two times greater, optionally at least three times greater, optionally at least four times greater, optionally at least five times greater, optionally at least six times greater. The critical current density is the current density that the battery cell can endure through cycling with cell failure due to dendrite growth. The high current density may specifically be a current density having a value that is greater than or equal to ±2 mA cm⁻² at the cell level, alternatively greater than or equal to ±4 mA cm⁻², alternatively greater than or equal to ±6 mA cm⁻², alternatively greater than or equal to ±8 mA cm⁻², alternatively greater than or equal to ±10 mA cm⁻², alternatively greater than or equal to ±12 mA cm⁻², alternatively greater than or equal to ±14 mA cm⁻², alternatively greater than or equal to ±16 mA cm⁻², alternatively greater than or equal to ±18 mA cm⁻², alternatively greater than or equal to ±20 mA cm⁻², alternatively greater than or equal to ±30 mA cm⁻², alternatively greater than or equal to ±40 mA cm⁻², alternatively greater than or equal to ±50 mA cm⁻². Similar to the cut-off voltage, the value of the high current density is dependent upon such factors as the battery cell composition and the configuration of battery modules and packs.

The short duration of the voltage pulse is preferably less than 1 millisecond (ms). The short duration also may be greater than or equal to 0.1 ms. Thus, the short duration may optionally be in the range of 0.1 ms to 1.0 ms, optionally in the range of 0.1 ms to 0.9 ms, optionally in the range of 0.1 ms to 0.8 ms, optionally in the range of 0.1 ms to 0.7 ms, optionally in the range of 0.1 ms to 0.6 ms, optionally in the range of 0.1 ms to 0.5 ms, optionally in the range of 0.1 ms to 0.4 ms, optionally in the range of 0.1 ms to 0.3 ms, optionally in the range of 0.1 ms to 0.2 ms.

In the method, the voltage pulse may be a single pulse or may include a plurality of (a set of) said pulses applied consecutively/sequentially. For example, the method may include at least 5 voltage pulses, alternatively at least 10 voltage pulses, alternatively at least 15 voltage pulses, alternatively at least 20 voltage pulses. Also, the voltage pulse may include a plurality of pulse cycles. In other words, the voltage pulse may be applied in between the galvanostatic cycling (e. g. between sets of charge-discharge cycling sequentially).

As shown in FIG. 2, the method may be applied after cell fabrication, or during use of the battery cell (e.g., during cell cycling), or both. For example, at step S102 a voltage pulse according to the method is applied after cell fabrication to reduce or eliminate the pores formed during fabrication and thereby increase interfacial contact. Then, when pores have formed at the interface in the cell after cycling, at step S104 a voltage pulse according to the method is again applied to heal the pores. Step S104 may be repeated periodically heal that cell after periods of repeated charging/discharging during use of the battery. As such, the method is performed in-operando, and thus can be performed during use of the battery without interruption of the battery function and does not require any disassembly of the battery.

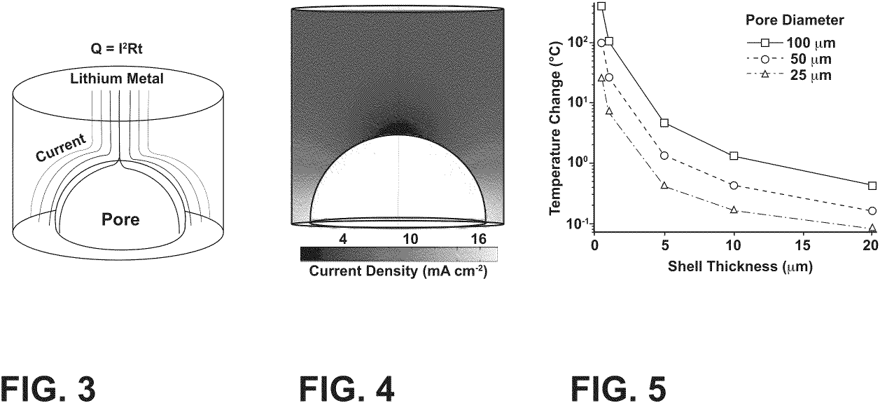

Without being bound by theory, the local current density in the vicinity of the pore is expected to be higher due to the absence of electronic pathway through the voids as shown in FIGS. 3 and 4. This redistribution of the current can lead to a rise in the temperature of the lithium metal due to Joule heating. Theoretical calculations and CFD simulations were carried out to assess the impact of interfacial pores on current density and local heating. A cylindrical geometry in the vicinity of the pore was considered in which the diameter of the pore was a variable and the cylinder diameter around it was specified as a function of a given shell thickness (FIG. 3). The height of the cylinder in all cases was considered equal to the diameter of the cylinder. Specifically, the temperature rise in lithium metal due to Joule heating was estimated by employing fundamental heat balance equations. A geometry as described visually in FIG. 3 was employed using a cylindrical element around an interfacial pore. The diameters of the cylinder (d_{cyl}) investigated were 100, 50 and 25 µm with the pore sizes ranging from d_{cyl}-0.5 µm to d_{cyl}-20 µm. The height of the cylinder was set equal to the diameter enabling the quantification of the feature of local heating around the pore. Heat generated from resistive heating was evaluated by,

$${Q}_{\text{resistive}} = {j}^{2} \cdot \text{R} \cdot \text{t} \qquad \text{(1)}$$

wherein Qᵣₑₛᵢₛₜᵢᵥₑ is the resistive heating, j is the current density during the pulse (mA·cm⁻²), R is the resistance (Ω·cm²), and t is the duration of the pulse (s). The heat generated was obtained on an area-specific basis (J·cm⁻²). This heat was assumed to be dissipated entirely within the cylindrical geometry considered. As the thermal conductivity of the underlying ceramic is significantly lower than the conductivity of Li metal, it is reasonable to assume the dissipation occurs primarily through the Li metal. While over time the energy released will dissipate through the bulk metal, the assumption provides an initial estimate for the impact of resistive heating. The temperature change arising from the resistive heating was evaluated by the following equation,

$${Q}_{r e s i s t i v e} = m \cdot {c}_{p} \cdot \text{Δ} T \qquad \text{(2)}$$

wherein m is the mass of lithium in the cylindrical element, cₚ is the specific heat of Li, and ΔT is the temperature change arising from the resistive heating.

CFD simulations illustrated that the current density in the vicinity of the pore increase by about four times compared to the applied current density. Specifically, as shown in FIG. 4, CFD modelling of the ion flow pathway through a similar geometry was carried out using COMSOL in order to understand the relative increase in the local flux at the pore edges. The simulated geometry consisted of a cylindrical element of Li metal (d_{cyl} = h_{cyl} = 120 µm) with a pore element (dₚₒᵣₑ = 100 µm) subtracted at the interface. The top surface of the cylinder was provided the normal current density of 5 mA·cm⁻², while the pore facing surface was considered to be ground with a distributed impedance of 4000 Ω·cm². The resultant mesh consisted of 10193 elements with an average element quality of 0.77 (volume/length ratio for mesh element).

High local current density can lead to preferential deposition in these regions during the plating cycle, which can lead to filling of the pores and improvement of the interface. The calculations for local temperature increase assumed that the electrical power associated with the local current density in the vicinity of the pore (J²R, where J is the local electric current density, and R is the area specific resistance) converts to heat. This heat was assumed to dissipated in the Li metal within the cylindrical element considered and the local temperature rise was estimated using standard heat capacity formulation. As shown in FIG. 5, results indicated local temperature rises ranging from ~10° C. up to 300° C. depending on the cylinder and pore geometry. Larger pores result in typically higher temperature changes due to the larger effective current density in the vicinity of these pores. In addition, increasing the cylinder diameter reduces the local heating due to an increase in the amount of material for heat dissipation. Higher local temperature of Li essentially implies an increased homologous temperature resulting in higher creep, and improved creep flow of Li can aid in reduction of the interfacial resistance. While the assumptions of heat generation and dissipation assumption are limiting, these results do provide an estimate for local temperature rise through Joule heating. Such a temperature increase can significantly affect lithium flow behavior and facilitate stabilization of the interface. Combined, the preferential deposition and improved creep flow leads to electrochemical stabilization of the anode | SE interface. The interface stabilization thus achieved by the present method functions by Li flow and surface diffusion through local heating at high current density.

### EXAMPLES

The present method is further described in connection with the following laboratory examples, which are intended to be non-limiting.

A symmetric Li | LALZO | Li cell was assembled inside a glove box using the Swagelok configuration. Specifically, commercial Al-doped LLZO (LALZO) powder acquired from MSE supplies was used for this study. The nominal composition of this commercial LALZO was Li_{6.25}Al_{0.25}La₃Zr₂O₁₂ with an average particle size 10 µm and a theoretical density of 5.2 g cm⁻³. The LALZO powder was stored inside a dry room and most of the processing was carried out either in the dry room or the glove box to minimize moisture induced impurities. Half-inch LALZO pellets were pressed by a uniaxial hydraulic press with 400 MPa pressure. These pellets were buried underneath the mother powder in MgO crucibles. Calcination was carried out to densify the pellets at 1200° C. for 12 hours in a muffle furnace in air. Sintered pellets were polished to shiny finish and stored inside the glove box. Three types of spring-loaded Swagelok cells were assembled to test the effect of the electrical pulse on interfacial resistance. The first cell was assembled by attaching Li foils directly on both side of the LALZO. Lithium metal foil size was the same for all types of assembly (diameter = 8 mm). All lithium foils were scratched by a metal brush prior to assembly. All cells utilized in the study were conditioned at 60° C. for 24 hours before electrochemical characterization. Galvanostatic cycling was carried out using the specified current densities. The cells were rested for 2 minutes after pulse before EIS spectra was collected.

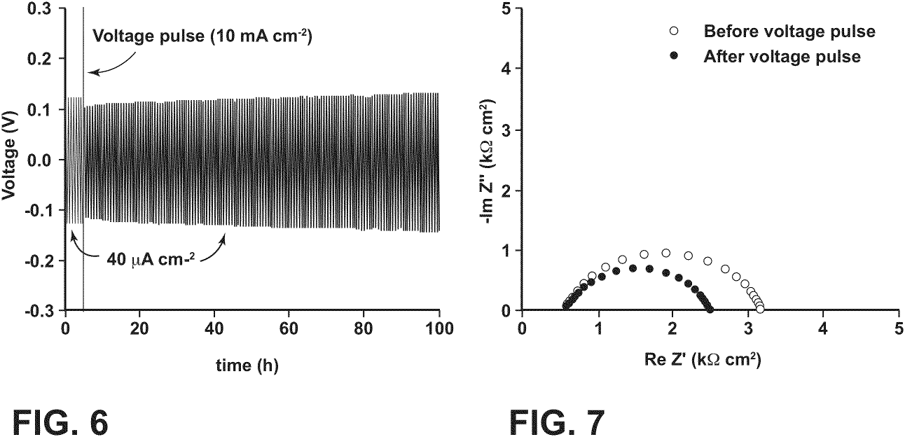

To replicate inhomogeneous Li morphology and void formation occurring during long- term cycling of SSB, the cell was conditioned such that the interface was intentionally non-optimal. Imperfect physical contact at the interface was validated by Electrochemical Impedance spectroscopy (EIS) measurement at room temperature which showed an interfacial resistance of 2.58 kΩ.cm². In comparison, typical impedance values for pristine cells with good contact between LALZO and Li are usually in the range of 10-100s of Ω.cm². During galvanostatic cycling at 40 µA cm⁻², the average cell polarization was 0.12 V as shown in FIG. 6. An increase of the average polarization after 30 minutes of platting and stripping cycles was found to be around 3 mV. The increase of polarization on cycling can arise from interfacial reaction or void formation at the interface. Since LALZO is stable against Li metal, void formation is likely occurring at the applied current densities. After five cycles, a voltage pulse was applied on the cell by application of high current (10 mA cm⁻²) with cutoff voltages set at 10 V and -10 V. Cutoff voltages are reached as soon as the 20 pulse is applied. EIS spectra after the application of this voltage pulse showed significant reduction in interfacial resistance as shown in FIG. 7. As seen from the EIS spectra, only the interfacial resistance of the cell decreases while bulk resistance remains constant. No change in bulk resistance indicates the absence of dendrite formation or propagation in the bulk of the solid electrolyte. The decrease in interfacial resistance suggests improvement in interfacial contact at the Li metal | SE interface. FIG. 7 indicates that interfacial resistance after 20 pulses was 1.90 kΩ.cm² which is 26% lower compared to the area specific resistance of the pristine interfacial contact. Presence of voids at the Li | SE interface diminish the electrochemically active area due to absence of ionic and electronic pathways leading to regions with higher local current density (current focusing). Application of the high current density pulse causes high lithium deposition at the pore edges leading to the improvement of the contact impedance as shown schematically in FIGS. 1 and 2. Subsequent galvanostatic cycling performed under the initial current density of 40 µA cm⁻² showed that the average cell polarization decreased from 0.12 V to 0.09 V (FIG. 6). Improved EIS spectra as well as lower polarization indicates the efficacy of improving the interfacial resistance through voltage pulse.

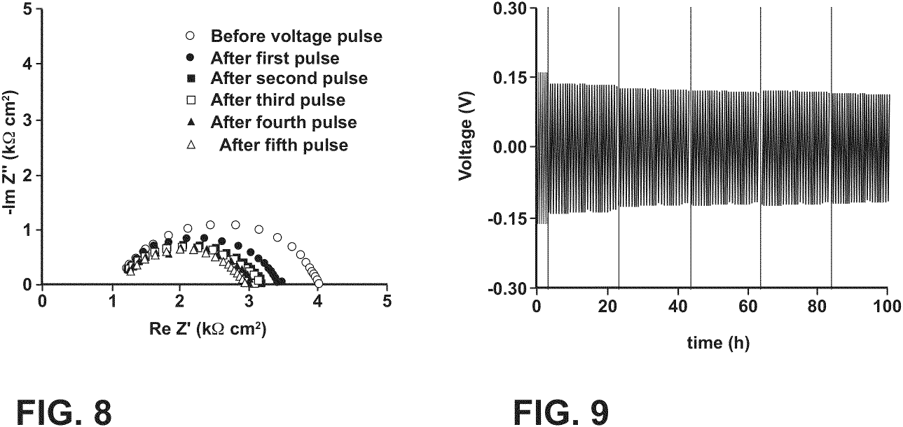

The effect of multiple pulse cycles (high current density voltage pulse cycles) on the cell performance was subsequently investigated. The interfacial resistance of the pristine cell was 2.89 kΩ.cm² which decreased to 2.30 Ω.cm² after the first voltage pulse showcasing 20% improvement in interfacial contact after the first pulse cycle as shown in FIG. 8. After a period of 20 hours of galvanostatic cycling at the nominal current density (40 µA cm⁻²) during which the average cell polarization was 0.161 V, 20 identical pulses were applied multiple times with 20 hours of galvanostatic cycling after each pulse as shown in FIG. 9. The interfacial resistance continued to decrease without any change in bulk resistance indicating an improvement of the contact at the anode | SE interface. The unchanged bulk resistance indicates that there is an absence of dendrite formation with the application of the voltage pulse. After five pulse cycles, the interfacial resistance decreased to 1.78 kΩ.cm² compared to the initial resistance of 2.89 kΩ.cm² (-38.4%). The interfacial resistance after each of the five pulse cycles is shown in FIG. 8. Thus, the experimental data provides a proof-of-concept for the present electrochemical method for improving contact impedance in Li | LALZO systems.

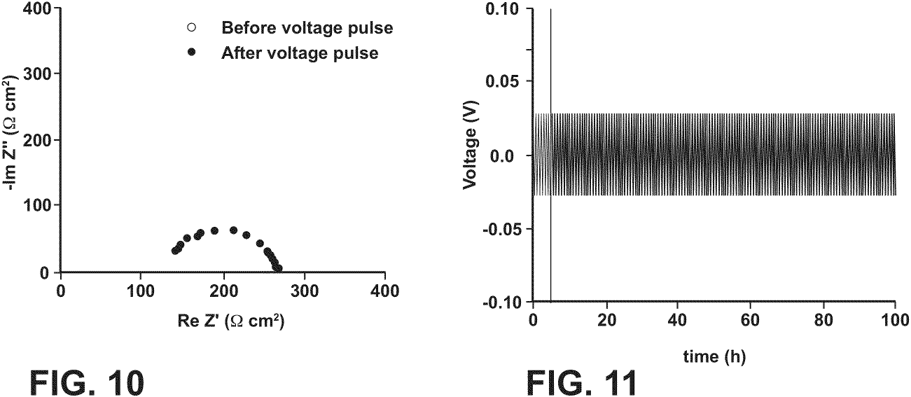

The impact of voltage pulse on a cell with intimate as-assembled contact at the interface was also studied, i.e. a cell that already has good interfacial contact due to lack of pores at the electrode-to-solid-electrolyte interface. Thus, similar symmetric Li | LALZO | Li cell were assembled and conditioned and operated at 60° C. to improve cell impedance. As shown in FIG. 10, EIS spectra revealed a very low interfacial resistance of 171 Ω.cm², which is comparable to resistance levels reported for Li | LLZO | Li cells with intimate contact at the interface and high critical current density. Electrochemical tests were carried out identical to the measurements above. The first few galvanostatic platting and striping cycles were performed at 80 µA cm⁻² which showed 0.02 V average polarization of the cell (FIG. 11). As mentioned above, the cell polarization profile reveals information about the efficacy of electrodeposition of Li ions at the electrode. Cell polarization increased by only 10 µV after 30 minutes of cycling and showed very flat, stable profiles indicating high coulombic efficiency, reversible electrodeposition and electrodissolution of Li metal. No interfacial void formation was expected after cycling.

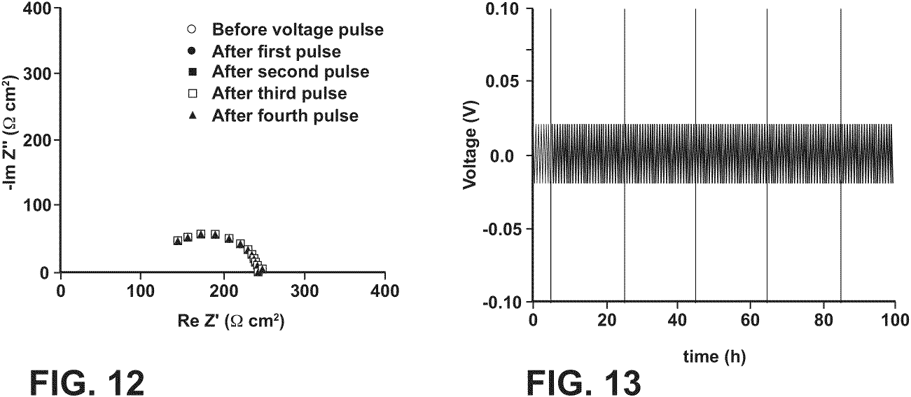

A high current density of 50 mA cm⁻² was then applied with 10 V and -10 V cut off voltage conditions. At a time, 20 voltage pulses were applied which took 0.3 s to complete. After pulse, no change in the EIS spectra and cell polarization were observed, as the EIS spectra after voltage pulse overlapped the EIS spectra for before the voltage pulse (FIG. 10). Galvanostatic cycling at the nominal current density after the pulse application revealed no degradation of the cell as shown in FIG. 11. Thus, the voltage pulse had no effect (i.e., no negative effect) on interfacial contact when applied to a cell already having good/pristine interfacial contact. Another cell was tested with multiple pulses which showed a similar response with no significant change in EIS profile (R_{contact} = 128.2 Ω.cm²) or cell polarization even after five pulse cycles as shown in FIGS. 12 and 13. Particularly, it is noted that the EIS spectra in FIG. 12 overlap for all of the data sets, including before voltage pulse, after first pulse, after second pulse, after third pulse, and after fourth pulse. These experiments suggested that while the voltage pulse technique addresses the interface issue for a non-ideal interface, it had no negative impact on a cell with intimate anode | SE interface contact. These results are vital to ensure that the method can be used in battery management systems to address and alleviate interfacial resistance challenges for defective cells without the concern of causing active degradation of cells having intimate interfacial contact.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of improving interfacial contact at an electrode-to-solid-electrolyte interface in a solid-state battery cell, the method comprising:
providing a solid-state battery cell including a solid-state electrolyte and electrodes defining an anode and a cathode, wherein each of the anode and cathode are adjacent to the solid-state electrolyte at an interface;
electrochemically increasing interfacial contact between at least one of the electrodes and the solid-state electrolyte by applying a voltage pulse to the cell at a high current density for a short duration, wherein electrode material diffuses into pores formed in the solid electrolyte interface, thereby healing the pores and eliminating an interfacial space charge effect.

2. The method of claim 1, wherein the voltage pulse has a cut-off voltage having an absolute value greater than or equal to 20 V at a cell level.

3. The method of claim 2, wherein the cut-off voltage of the voltage pulse has an absolute value greater than or equal to 10 V at a cell level.

4. The method of claim 1, wherein the high current density applied to the cell is at least five times greater than the critical current density at a cell level.

5. The method of claim 1, wherein the high current density applied to the cell is greater than or equal to 10 mA cm⁻² at a cell level.

6. The method of claim 1, wherein the short duration is greater than or equal to 0.1 ms.

7. The method of claim 6, wherein the short duration is in a range of 0.1 to 0.5 ms.

8. The method of claim 1, wherein the short duration is less than 1 ms.

9. The method of claim 1, wherein the voltage pulse includes more than one pulse cycle.

10. The method of claim 1, wherein the solid-state electrolyte is one of an inorganic solid electrolyte, a solid polymer electrolyte, and a composite polymer electrolyte.

11. The method of claim 10, wherein the solid-state electrolyte is one of a garnet, a NASICON, a LISICON, an argyrodite-like, a lithium nitride, a lithium hydride, a lithium halide, a lithium phosphorous oxynitride, a lithium thiophosphate, a perovskite, a polyether-based electrolyte, a polycarbonate-based electrolyte, a polyester-based electrolyte, a polynitrile-based electrolyte, a polyalcohol-based electrolyte, a polyamine-based electrolyte, a polysiloxane-based electrolyte, a fluoropolymer-based electrolyte, a gel polymer electrolyte, an ionogel electrolyte, and a gel electrolyte.

12. The method of claim 1, wherein the anode comprises a Li-based active material, a Na-based active material, a K-based active material, a Mg-based active material, or a Zn-based active material.

13. The method of claim 1, wherein the pores in the solid-state electrolyte are reduced or completely filled up due to local heating of the anode material at the interface in the vicinity of the pores.

14. The method of claim 1, wherein the method is performed in-operando.

15. A solid-state battery cell having an electrochemical performance improved by the method of claim 1.
